(19) United States
(12) Patent Application Publication
(10) Pub. No.: US 2008/0241455 A1
(43) Pub. Date: Oct. 2, 2008

(54) Encapsulated Members, and Processes and Apparatuses for Forming Same

(76) Inventors: Panfilo M. DiNello, Clinton Township, MI (US); Robin L. Pointer, St.Clair Shores, MI (US); Lynn E. Cargill, Mt. Clemens, MI (US)

Correspondence Address: CARGILL & ASSOCIATES, P.L.L.C., 56 MACOMB PLACE, MT. CLEMENS, MI, 48043, US

(21) Appl. No.: 11/996,487

(22) PCT Filed: Jul. 24, 2006
(86) PCT No.: PCT/US06/28707

§ 371 Date: Jan. 22, 2008

Related U.S. Application Data
(60) Provisional application No. 60/701,661, filed on Jul. 22, 2005.

(51) Int. Cl. B32B 3/02

(52) U.S. Cl. 428/58

(57) ABSTRACT

An encapsulated member made with open molds for forming the exterior surface of the encapsulated member, wherein the encapsulation is accomplished with at least an outer skin configuration of a plastic, metal, ceramic or other moldable material for encapsulating pre-forms, reinforcements, sheeted materials, metallic pre-forms and other core materials that can be protected from the outer elements and manufacturing considerations. FIG. 3c shows an encapsulated reinforced member located within an open mold having skins thereon, and being filled in between with foamable material.

### CROSS REFERENCES TO RELATED APPLICATIONS

This application claims the benefit of U.S. Provisional Patent Application No. 60/701,661 filed on Jul. 22, 2005, which is incorporated by reference herein

### BACKGROUND OF THE INVENTION

This patent application generally relates to encapsulated members by the forming of meltable materials, including plastic or metal around a member, and more specifically, relates to encapsulated magnesium and other materials by the forming of plastic and/or a metal around a member using a heated mold in contact with particulates of plastic and/or metals, whether they be in the form of powder, resins, pellets or the like.

Although conventional methods of forming encapsulated members exist, there is always room for improvement. There are many ways to make plastics and metals, but there are few ways to make plastic or metal articles which have good material properties such as being lightweight, strong, fire retardant, bullet proof, mine proof, insulative, impact resistant, as well as potentially having a decorative, textured or functional skin, or made in a single composite on a heated mold. Furthermore, there are limited teachings in the prior art of embedding articles within an encapsulant, in order to either reinforce the article or to change its properties. Moreover, there are even less ways known in the art for including various materials throughout the body of an article without having seams, including multiple layer structures and various materials dispersed throughout the surface of the article.

Although it is known to put inserts into injection molded plastic articles, the present inventors are not aware of many low pressure encapsulating methods which can completely suspend, and form at least one molded surface thereover, a pre-form, insert, reinforcement, foam core or other sandwiched material within an encapsulating plastic or metal material itself that is structurally sound and relatively inexpensive. It would be advantageous for such encapsulated members to be provided, as well as methods for making them. These methods are of particular interest as they utilize relatively low temperatures, ambient pressures and use inexpensive and easily machined molds which will last for an entire production of an article. Of course, it would also be advantageous for such a method to be capable of using recycled materials.

Such a new encapsulated member, and method of forming the same, would be usable for a huge multitude of applications, including, but certainly not limited to: automotive and industrial vehicle components; modular housing panels; airplane components; consumer and industrial furniture such as tables, tabletops and the like; doors; windows; material handling pallets and other articles; consumer goods; industrial articles; marine applications and boat hulls; molds and components, including seawalls, boat hulls and the like; medical apparatuses and other applications; scaffolding and other building construction articles; sea containers; railroad containers; composite wheels for trains and other vehicles, as well as food shipping containers including food containers of all sizes and shapes, just to name some of the applications. Each of these applications will include various forms of the encapsulated articles, including various materials sandwiched between two or more skins in order to produce the desired material properties.

One of the largest applications for the present invention and technology is the creation of big items, such as aerospace, aircraft, and automobile vehicle components, including pick-up truck boxes, roof components, underbody components, and the like. The aerospace industry has always sought out lightweight components for aircraft construction. Aluminum has traditionally been the material of choice as it is lightweight and non-corrosive. However, except for the fact that magnesium cannot be exposed to outer elements, the aerospace industry would like to use magnesium for its structural components as it is just as strong as aluminum, yet lighter in weight, and is very reasonably priced, with an abundant world supply. By encapsulating any magnesium component, the outer elements will not be able to corrode the surface of the magnesium.

The aircraft industry would benefit greatly by the possibility of a new type of lightweight component. Especially one that is resistant to the corrosion possibilities of the outer elements. In fact, each ounce that can be shaved off of the component weight can make a difference. When considering the effect of reducing the weight of a cargo plane by a significant amount, a whole new set of cargo possibilities opens up, as more cargo can then be shipped while maintaining a constant weight. In addition, the possibility of one metal encapsulating another, i.e. aluminum melted and molded around a plastic encapsulated magnesium core, opens up a new realm of products that could be very useful in the aerospace and aircraft industry.

Furthermore, in the automotive industry, which has traditionally used steel for its components, the automotive vehicle manufacturers in Detroit and abroad are seeking lightweight metal and plastic composite components for their vehicles because the new stricter fuel economy regulations are forcing them to rethink how they manufacture vehicles. As they are currently making as many parts as they can out of aluminum and composites, the addition of a possible new encapsulant manufacturing method, and their resulting products, reaches out past steel and aluminum and brings in the possibility of a combined metal/plastic component that should perform well.

Auto companies are eager to use magnesium components in their vehicles due to its high strength and extremely low weight. However, magnesium is very prone to corrosion and cannot come in contact with air or other metals without deleterious effects. Encapsulated magnesium would alleviate the corrosivity of the inner core by encapsulating the magnesium component in another material such as plastic. As the encapsulated magnesium parts will weigh less than comparable aluminum parts, better fuel efficiencies would be realized.

Environmentally friendly politicians in various governments, including Washington, D.C., are backing regulations which will press the automotive industry hard into developing more fuel-efficient vehicles. Currently, the best selling vehicles in the United States are heavy trucks and sport utility vehicles, all of which have poor fuel economy due to their massive size and incredibly high weights. Most of these vehicles weigh a lot, i.e. 4,000 to 6,500 pounds, and normal side roads with a gross weight limit of one and a half tons will crack under a sustained weight load such as occurs with these vehicles. By replacing major structural components with lightweight encapsulated magnesium components, great reductions in weight will be seen.

The Corporate Average Fuel Economy, or “CAFE”, is increasingly putting demands on the automotive industry because of the growing evidence of the vehicle pollution-caused greenhouse effect and other environmental maladies. A change to encapsulated components has huge implications for the American automotive industry which is already facing pinched profits. Automakers say that tougher mileage regulations, particularly for sport utility vehicles, could cost each of the companies several billion dollars over the next few years and would seriously hurt their profits.

It would further be advantageous to be able to provide inexpensive forms of modular housing panels, which can be clipped together and caulked in place to make rapid housing. There has been a long felt need for a cheap, lightweight and inexpensive, insulated clip-together housing component which can be manufactured on-site, as well as being capable of being manufactured in a plant back at a home base and then shipped to the location itself. As one may be aware, Rubbermaid Corporation of Ohio in the United States makes many little work sheds and garden sheds for use in a back yard, although these sheds are not suitable for human living conditions. However, those sheds are made by methods which do not lend well to even larger products, and the molds would be extremely expensive for ones of that size to be used for production. It would be a great advantage to utilize encapsulated members, recycled materials and insulation which can be encapsulated within a composite article such that a useful modular house can be made in a very short period of time.

### SUMMARY OF THE INVENTION

Therefore, in accordance with the above objects and advantages, the present invention discloses an encapsulated member having an outer multiple skin configuration, preferably including at least two skins of plastic, metal, ceramic, or any other moldable material, which may also have contained therebetween an interior member component of any number of layers, and may also include an expandable plastic material, reinforcements for strengthening the plastic article, other filler materials, or combinations thereof. In addition to the materials which can be incorporated into the middle layer between two skins, the present invention also discloses the use of many embedded articles to be placed between the two skins, whether they are completely embedded into the article, or whether portions of them are allowed to extend therethrough outside the molded article, i.e. for purposes such as mounting brackets, electrical wires, and the like.

In essence, the present invention discloses a one-piece cast component having two skins on either side with at least one filling material between the two skins. The two skins may be made of melted plastic powder, liquid cast powder plastic, thermoset plastic resins, low melting point metals, ceramic slips, sand and resin combinations, various glasses, crumbed or liquid rubber, cellulosic materials, wax, or any combination thereof, in addition which will form a moldable material for this application.

Multiple layers are also capable of being made by methods performed in accordance with the present invention, including, but not limited to, numerous combinations of plastics/metals and/or plastics/foam/metals, etc. Furthermore, one of the layers may also include powder coating or in-mold paints. For instance, if the mold could be electrostatically charged, a releasable or lubricious powder coat paint could be first contacted with the heated mold, and then could cure at its proper temperature while the heated mold is accepting its contact with plastic particulates for producing a skin on top of the powder coated paint. Other multi-layer concepts are envisioned by the present inventors, which may also include pre-forms, reinforcements or other materials to be sandwiched between multiple skins of plastic such as made by the multiple mold configurations, where one of the plastic layers may be an encapsulant for a previously formed and encapsulated member.

For example, heated male and female complementary molds can each have a skin formed on their complementary face portions, followed by an expandable or foamable plastic being sprinkled onto either of the molds. In addition, a reinforcement, such as a metal wire mesh, may be shaped into the appropriate shape and inserted between the two skins. The two skins can then be spaced apart from one another such that the expandable foam will expand to the predetermined thickness, thereby embedding and surrounding the metal mesh which has been placed between the two skins. This configuration, i.e. the sandwich with the reinforcement therebetween, is capable of adding structural strength while maintaining a lightweight and inexpensive plastic configuration, which is much more lightweight than steel.

Therefore, in accordance with the present invention, there are numerous important embodiments, including, but not limited to, methods of manufacturing an encapsulated member, resulting products, and some embodiments of the apparatus for making the encapsulated members. In one embodiment, the method is accomplished by utilizing an open mold made of aluminum, steel or any other suitable material which can be worked to impart a desired shape, heated and then contacted with a plastic or metal particulate to melt the particulate onto the mold itself, thereby producing a skin of either a plastic, ceramic or the metal. In another embodiment, male and female complementary molds made of similar materials can be heated on their face portions to a temperature above the melting point of a meltable particulate into which it comes in contact, and then the male and female articles can be pressed or held together to form a double-skinned article.

In yet another embodiment, a double-skinned encapsulated article can be manufactured using the male and female complementary molds from above, with the introduction of a preform and a plastic filler material onto one of the molds prior to holding the molds together, such that there is a “sandwich” which is formed from these plastic composites. In yet a further embodiment, the double-skinned embodiment further comprises an expandable plastic filler material which will give a double-skinned plastic article with an expanded plastic filler material therebetween. A predetermined thickness for the expandable plastic is created by holding the male and female molds at a predetermined distance apart. In yet another embodiment, pre-forms and/or reinforcements can be embedded into the plastic filler material or into the expandable plastic filler material such that when the expandable material is heated and expanded up around the reinforcement, the reinforcement is embedded into and surrounded by the expandable plastic filler material.

In yet still another embodiment of the present invention, mounting brackets, wiring harnesses, and/or any other desired components or materials may be encapsulated within the plastic composite article itself or they may be inserted into the mold prior to the two skin molds being placed in close proximity to one another, such that the plastic skin and the filler material can embed and encapsulate the mounting brackets, wiring harnesses or the like, perhaps allowing a certain portion of the component to extend outside of the finished encapsulated component to allow access to the component. For example, it may be advantageous to place a mounting bracket between the two skins already in the mold, such that a portion of the mounting bracket is extending therefrom. Then, the two skins can be held together and heated to allow for them to melt together and form an encapsulation around the part of the mounting bracket that is between the molded areas, while leaving a portion of the mounting bracket exposed for attachment wherever it is desired.

In addition, apparatuses for accomplishing these types of articles and processes are also disclosed, including a trunion design for moving and tipping the male and female mold sections to produce articles. Robots may be utilized to load reinforcements between the male and female molds prior to the filler material being melted or expanded. A vacuum apparatus for filling/emptying the plastic particulate into and around the mold is also disclosed incorporating a vacuum system and a blow bag for removing the excess plastic particulate once a desired skin thickness has been achieved. Further, plastic particulate from additional blower bags may be connected to the vacuum system in order to form layers of various other materials. These method steps may also be employed with other meltable materials, including metal powders.

In yet one more embodiment of the present invention, there are disclosed various particular articles which are made by the process of the present invention, including, but not limited to, automotive components, industrial tabletops, airplane components, modular housing panels and components, material handling pallets, and many other applications which will be described hereinbelow or which will become obvious to one of ordinary skill in the art.

Therefore, in accordance with the present invention, there is disclosed new processes for forming plastic, apparatuses for carrying out those processes, and articles which are made therefrom. For understanding the present invention, we refer the reader to the following detailed description, taken in conjunction with the accompanying drawings and the accompanying text.

### BRIEF DESCRIPTION OF THE DRAWINGS

FIG. 1A is a side elevational view of a basic encapsulated member made in accordance of the present invention;

FIG. 1B is a side elevational cutaway view of an encapsulated member with fillers made in accordance with one of the embodiments of the present invention;

FIG. 1C is a perspective view of a foamed encapsulated member made in accordance with one of the embodiments of the present invention;

FIG. 1D illustrates a side elevational cutaway view of a double encapsulated member, which is another embodiment of the present invention;

FIG. 1E is a side elevational cutaway view of a double encapsulated reinforced member;

FIG. 1F is a side elevational cutaway view of an encapsulated cardboard member;

FIG. 2A is a perspective view of a sheeted encapsulated member having various materials incorporated into the surface, which have different properties;

FIG. 2B is an encapsulated cross member made in accordance with one of the embodiments of the present invention;

FIG. 2C shows an encapsulated mounting member made in accordance with one of the embodiments of the present invention

FIG. 3A is a side elevational cutaway view of another embodiment of a pair of complementary molds having particulate materials contacting the inner surfaces;

FIG. 3B illustrates the skin formed on the interior surfaces of the molds, after the excess particulate material has been removed from therein;

FIG. 3C shows an encapsulated reinforced member located within an open mold having skins thereon, and being filled in between with foamable material;

FIG. 4A is a side elevational cutaway view of another embodiment of a pair of complementary molded metallic skins having a plastic material in the center between the skins;

FIG. 4B is a side elevational cutaway view of still another embodiment of a pair of molded metallic skins having a foamed material in the center between the skins;

FIG. 4C is a side elevational cutaway view of yet another embodiment of a pair of molded metallic skins having a plastic encapsulated metallic preform in the center between the skins;

FIG. 4D is a side elevational cutaway view of another further multi-layer embodiment of a pair of molded metallic skins having a multi-layer structure therebetween, including a plastic encapsulated metallic preform in the center between the skins, in addition to a foamed material on at least one side of the preform;

FIG. 5A is a side elevational cutaway view of another embodiment of a pair of complementary molded metallic skins having a plastic material in the center between the skins;

FIG. 5B is a side elevational cutaway view of still another embodiment of a pair of molded metallic skins having a foamed material in the center between the skins;

FIG. 5C is a side elevational cutaway view of yet another embodiment of a pair of molded metallic skins having a plastic encapsulated metallic preform in the center between the skins;

FIG. 5D is a side elevational cutaway view of another further multi-layer embodiment of a pair of molded metallic skins having a multi-layer structure therebetween, including a plastic encapsulated metallic preform in the center between the skins, in addition to a foamed material on at least one side of the preform;

FIG. 6A shows the first step in the method of the present invention;

FIG. 6B shows the resulting skin;

FIG. 6C illustrates the removal of the skin;

FIG. 7A is a side elevational cutaway view of a multi-layer structure;

FIG. 7B is a side elevational cutaway view of another multi-layer structure;

FIG. 8 is a top plan view of a powder mold processing station;

FIG. 9 is a perspective view of a pick-up truck box reinforcement relative placement;

FIG. 10 shows the relative placement of the reinforcing bars in the mold;

FIG. 11 illustrates the particulate hoppers and the tipping molds;

FIG. 12 illustrates the two halves of the mold held together;

FIG. 13 shows a cutaway of the pick up truck bed; and

FIG. 14 is another cutaway view of the pick up truck box.

### DETAILED DESCRIPTION OF THE DRAWINGS

In accordance with the present invention, there are disclosed various processes for forming plastic, the apparatuses which are useful for performing those processes, and certain articles made therefrom. Needless to say, the scope of the invention will be determined by the claims and shall not be otherwise limited. As with all new materials and forming technologies, the number of applications and permutations of those applications are so numerous, they cannot all be mentioned here. However, in the spirit of providing the best mode and detailed description of many of the embodiments, the following description will be broken down into paragraphs, beginning with a generalized description of the technology, followed by specific applications and their descriptions.

### I. General Description

The present invention generally describes an open mold formed encapsulated member, which means that there is an interior component surrounded by two skins on either side. As will be more fully described hereinbelow, the interior component may be essentially anything, including preforms, foamed core, inserts, reinforcements, conduits, or nearly anything that has a melting point higher than the melting point of the material used for the skins. The skins maybe made of moldable or meltable material that may be formable around the interior component.

Generally speaking, the moldable material skins may be any moldable or meltable material, although it is preferably plastic, metal, or a slip cast ceramic. These skins are generally either meltable, moldable, or they may simply be formable at room temperature. A typical encapsulated member, made in accordance of the present invention may include the use of a magnesium preform which is thereafter encapsulated between two plastic skins made in open molds, especially via the method disclosed and claimed PCT Application numbers PCT/US2002/003298 and PCT/US2003/030843.

In the most preferred embodiment, a pair of heatable molds is contacted with a particulate plastic material, such as polyurethane, polypropylene, or polyethylene, and shall remain in contact with the mold until a two to five millimeter thick skin is melted onto the heated molds. The excess particulate material is thereafter removed, and the two heated molds are then situated so as to encapsulate any insert or reinforcement, such as a magnesium preform, whereby the plastic skins melt and form together acting as an sealant around the magnesium preform, insert or reinforcement, permanently encapsulating the preform between the plastic skins. This results in an extremely corrosion resistant component where the plastic skins encapsulate the insert, and shield it from the outer elements. This is especially beneficial for magnesium preforms, as the magnesium is susceptible to corrosion and breakdown in normal atmospheric conditions.

Utilizing a magnesium preform in the middle of one of our encapsulated members, one can realize the strength of the magnesium while providing an environmentally stable magnesium component. This combination will find great utility in many industries, including the aircraft and automotive industries.

Although a single mold can produce a single piece of a plastic article merely by contacting the heated mold into a reservoir of plastic, it is further envisioned that an encapsulated sandwich-type of composite material can be made by making both male and female mold portions, forming “skins” on each of the molds, and placing materials in between the two skins in a clamshell-type configuration with a filler or foaming plastic in between. Generally, the expandable foam is activated by the residual heat from the molds, and helps to encapsulate any inserts which have been placed into the mold prior to expansion of the foam.

In the event that male and female mold skins are utilized, any type of reinforcing material or desired insert may be sandwiched between the two skins and may be fully surrounded by the filler or expandable foam plastic. For example, to add structural strength, it is envisioned that a whole host of reinforcements may be used, including metal preforms, magnesium preforms, steel preforms, etc. Especially strong is a metal mesh inserted between the two skins along with expandable plastic material which will attach the two skins to one another, while embedding the steel mesh therebetween. In yet another reinforcement embodiment, a sheet of Kevlar, a registered trademark of DuPont Corporation of Wilmington, Del., can be introduced between the skins and within the foamed plastic in order to provide a bulletproof door, for example, for airplane cockpit door applications. Small individual wire mesh cones may be utilized for superior strength.

Furthermore, crumbed tire may be incorporated into the center of the male and female mold skins in order to make it nailable for modular housing applications. If it is desired that the plastic article needs to be cut to shape, then the insert/reinforcement material sandwiched between the male and female mold skins may be made of small particles such that the article can be machined or cut.

Any of the inserts or reinforcements may be pre-treated to aid in the adhesion between layers, or to help prevent the insert or reinforcement from cutting or shearing the foamed plastic that encases it, when under load. Such pre-treatments may include power-coating a wire mesh with a compatible epoxy resin; or applying a sulfonating gas via a sulfonating technique to individual particulates of the plastic, tire crumb or other recycled materials, to enhance their adhesion; or plating and/or depositing certain metallic or non-metallic coatings onto the insert/reinforcement to enhance adhesion; or even structural treatments such as sandblasting, surface grinding, tackifying with chemical treatments or the like; or the application of heat treatments such as annealing and/or quenching to change the surface properties; or the application of magnetic fields; or by forming an easy-to-adhere-to surface by forming or etching the insert/reinforcement to resemble reticulated foam by increasing the surface area.

Furthermore, it is envisioned by the present inventors that multiple layer structures can be formed by first making a male or female mold skin, followed by making a second male or female mold skin, and then a third complementary and mating male or female mold section can be formed. Each of these forms can be placed one on top of the other and heated with or without a filler material or foamable plastic in between, or with other materials which will melt and attach the skins altogether.

It is yet further envisioned by the present inventors that lower temperature melting materials may be used to encapsulate other materials, such as a lower temperature melting metal may be encapsulated by two skins of higher temperature melting metals, such as with a magnesium core surrounded by an aluminum alloy exterior skin. This material may then be encapsulated within a pair of plastic skins, to enhance the property of corrosion resistance, or for any other purpose.

Because certain embodiments of the present process are done at a relatively low temperature, i.e. slightly higher than that of the melting point of the plastic particulate being contacted with the heated mold, the mold itself will last a long time. In conventional injection molding, the plastic must be elevated in temperature to over 1,000° F., and commonly up to 1,500° F. in the worm screw before it is injected into the mold. With the combined effect of these high temperatures and high pressures used, the mold rapidly degrades. Also, the present invention is done in ambient pressure, rather than the many tons of pressure required by injection molding machines. Of special interest to all manufacturers, is the fact that the molds which can be used in the present invention may be made of pure aluminum or inexpensive and recyclable aluminum alloys such as kirksite which are cheap to make and easy to machine. Because of the low temperature and low pressure application, the molds do not degrade as they do in injection molding. For example, a mold used to make the entire truck bed box would cost more than a million dollars for a typical injection mold production mold, while the present invention mold can be made for less than one-tenth of that price. This factor alone will encourage new products because of the lower necessary up-front costs.

In another preferred embodiment, a steel preform maybe encapsulated between two ultra light metal skins which have been melted against a heatable mold, and encapsulating the steel preform insert.

Such encapsulated members will find utility in many industrial applications, which are to numerous to list herein. The encapsulated members may incorporate rigid and strong inserts that are encapsulated in plastic in order to provide essentially corrosion free coating around a rigid interior component, which provides strength and durability. If, on the other hand, an encapsulated member is desired which is light weight in nature, it would be possible to provide a double skinned encapsulated member having an interior component of foamed plastic or ceramic, such that the interior component provides a very light weight material having more rigid exterior skins.

Therefore, the present invention will be described with particular preferred embodiments, although it shall not be limited in scope to the exampled which have been described herein.

### II. Particular Embodiments

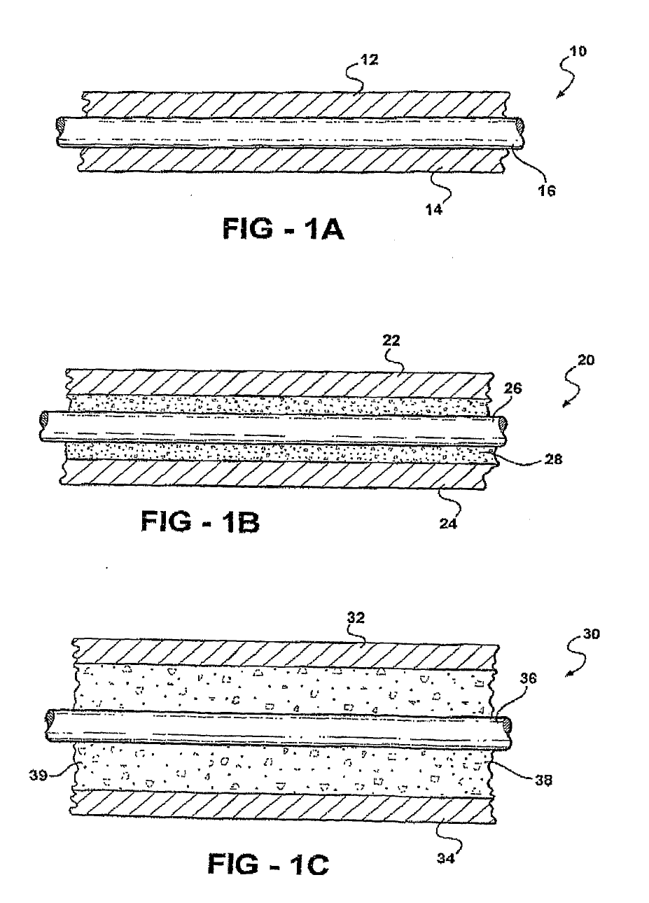

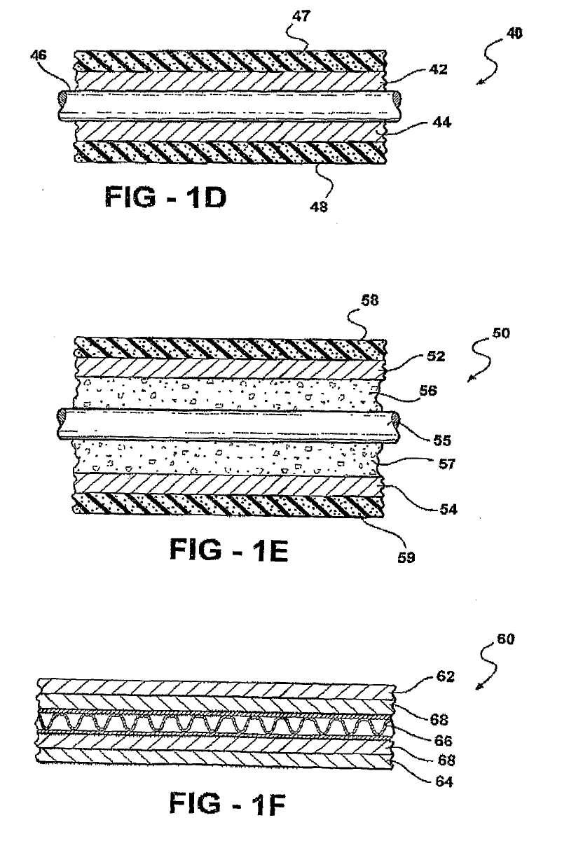

FIG. 1A is a cross sectional cutaway view of a very basic encapsulated member made in accordance with a first embodiment of the present invention, and is generally denoted by the numeral 10. Included are a first exterior skin 12 and a second exterior skin 14 and an interior component 16 located therebetween. First exterior skin 12 may be made of any suitable moldable, meltable or formable material, including a melted particulate plastic or particulate lightweight metal, any suitable thermoplastic material, or a liquid thermoset material.

As used herein and in the claims, the term “thermoplastic material” means a plastic material that has a softening or melting point, and is substantially free of a three dimensional crosslinked network resulting from the formation of covalent bonds between chemically reactive groups, e.g., active hydrogen groups and free isocyanate groups. Examples of thermoplastic materials from which the thermoplastic material may be fabricated include, but are not limited to acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), ionomers, liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polyethylene terephthalate (PET), polycyclohexylene dimethylene terephthalate (PCT), polycarbonate (PC), polyketone (PK), polyester, polyethylene (PE)/polythene/polyethene, polyetheretherketone (PEEK), polyetherimide (PEI), polyethersulfone (PES), polyethylenechlorinates (PEC), polyimide (PI), polylactic acid (PLA), polymethylpentene (PMP), polymethyl methacrylate (PMMA), polyphenylene oxide (PPO), polyphenylene sulfide (PPS), polyphthalamide (PPA), polypropylene (PP), polystyrene (PS), polysulfone (PSU), polyvinyl chloride (PVC) and spectralon. The thermoplastic material may optionally include additives, selected from, for example: light stabilizers, UV stabilizers, thermal stabilizers, antioxidants, fillers, pigments, dyes, waxes and combinations thereof.

Second exterior skin 14 made also be made of the same material as exterior skin 12, or may be made of a different material depending on the desired end result. It may be that the desired result of the present invention to provide a one-piece cast component encapsulated member. Interior component 16 may be virtually anything, such as a thermoset plastic material, a liquid foam, preforms of any type, metal foams, fillers, ceramics, crumbed tires, or any other material which does not substantially melt at a different temperature than the melting temperature of the exterior skins.

As used herein and in the claims the term “thermoset plastic material” means plastic materials having a three dimensional crosslinked network resulting from the formation of covalent bonds between chemically reactive groups, e.g., active hydrogen groups and free isocyanate groups.

In this embodiment, interior component 16 is preferably a metal preform or metal foam. The metal preforms may include magnesium, aluminum, copper, ttitanium, or/and alloys of these or other metals, such as steel. As used herein and in the claims the term “metal preform” means a metal provides a supporting structure that has been subjected to preliminary, usually incomplete shaping or molding before undergoing complete or final processing. The metal foams maybe include, but are not limited to aluminum, carbon, copper, graphite, hafnium over carbon foam, lead, nickel, nickel-chromium alloy, niobium over carbon foam, rhenium over carbon foam, stainless steel, tantalum over carbon foam, tin, titanium, tungsten over carbon foam, zinc, and zirconium over carbon foam.

Magnesium may be the most preferred interior component in this and following embodiments because it is the eighth most abundant element, constitutes about 2% of the Earth's crust by weight and it is the third most commonly used structural metal, following steel and aluminum. Magnesium, in its purest form, can be compared to aluminium, and is strong and light, so it is used in several high volume part manufacturing applications, including automotive and truck components. Historically, magnesium was one of the main aerospace construction metals. However, due to low corrosion resistance, the application of magnesium in the aerospace industry was significantly reduced during the 1960s and 70s. As shown in this application when it is encapsulated with plastics, magnesium has a good chance of becoming an aerospace metal again.

Looking next to FIG. 1B, there is shown an encapsulated member, generally denoted by the numeral 20, and also including a first exterior skin 22 and a second exterior skin 24. Additionally, an interior component 26 is located therebetween, and may further include tiny filler material pieces 28 in order to provide a lightweight structural encapsulated member. As shown in FIG. 1B, the filler material pieces 28 may be bits of any type of material, including, but not limited to, whiskers, powders, crumbs, chunks, pellets, or any other type of material which can be inserted between the first and second exterior skins 24 and 22, respectively, to improve the properties of the encapsulated member. Exterior skins 22, 24 and interior component 26 maybe of similar materials as described hereinabove with reference to FIG. 1A.

In FIG. 1C, there is shown a multi-layer encapsulated member generally denoted by the numeral 30, and also including a first exterior skin 32 and a second exterior skin 34. Additionally, similarly to FIG. 1A above, there is an interior component 36 as well as a new foamable material 39. As shown in FIG. 1C, the foamable material 36 may be heat activated after the two skins are held in close proximity and the interior component has been inserted before the foam is activated. Once the foam has been activated, it will expand and seep through the openings of the interior component 36 and will support the interior component between the exterior skins 22 and 24. As one can imagine, foamable material 39 can be of any suitable configuration. It may be preferable to secure the interior component 36 with a foamable material 38 that may or may not include filler material pieces 38. Exterior skins 32 and 34; and interior component 36 may be made of similar materials as described hereinabove with reference to FIG. 1A, while filler material pieces 38 may be made of similar materials as described hereinabove with reference to FIG. 1B.

FIG. 1D illustrates a side elevational cutaway view of a double encapsulated member, generally denoted by the numeral 40. The double encapsulated member 40 is similar to the encapsulated member 10 mentioned above, having a first exterior skin 42 and a second exterior skin 44 encapsulating an interior component 46. In addition, the double encapsulated member 40 includes a third exterior skin 47 and a fourth exterior skin 48 to further encapsulate exterior skins 42 and 44, respectively. The exterior skins 42, 44, 47 and 48 may be made of the same material or different material. As shown in FIG. 1D, the exterior skins 42 and 44 of this embodiment are made of the same material; exterior skins 47 and 48 are made of the same material, but different from that of skins 42 and 44. Exterior skins 42, 44, 47 and 48 and interior component 46 may be chosen from materials described hereinabove with reference to FIG. 1A.

FIG. 1E is a side elevational cutaway view of a double encapsulated reinforced member, generally denoted by the numeral 50. The double encapsulated reinforced member 50 is similar to the encapsulated member 30 mentioned above, having a first exterior skin 52 and a second exterior skin 54 encapsulating an interior component 55. Filler material 56 and foamable material 57 are inserted and formed between the skins 52 and 54 to improve properties, support the interior component and fill the gap. To further enhance the strength of the encapsulated member 50, a third exterior skin 58 and fourth exterior skin 59 may be formed to further encapsulate the interior component 55. As shown in FIG. 1E, the exterior skins 52 and 54 of this embodiment are made of the same material; exterior skins 58 and 59 are made of the same material, but different from that of skins 52 and 54. Exterior skins 52, 54, 58 and 59; and interior component 55 may be chosen from materials described hereinabove with reference to FIG. 1A, and filler material pieces 56 may be selected from materials described in FIG. 1B.

### II. Particular Embodiments

FIG. 1F is a side elevational cutaway view of an encapsulated cardboard member, generally denoted by the numeral 60. The encapsulated cardboard member 60 includes exterior skins 62 and 64 and an interior component 66. The interior component may be made of any suitable cardboard; preferably the cardboard is a double skinned protective covering manufactured by Blake Products, L.L.C. in Harrison Township, Mich. The double skinned protective coverings of Blake Products are suitable structural material because they are lightweight and capable of holding at least 500 pounds. Before being encapsulated by exterior skinned plastics, cardboards may be pre-treated by spray-on polyurethane 68, (e.g., Rhino Linings® spray-on polyurethane), which provides the protection for cardboard surfaces from abrasion and impact. Similar to the embodiments described above, exterior skins 62 and 64, and interior component 66 may be selected from materials described in FIG. 1A.

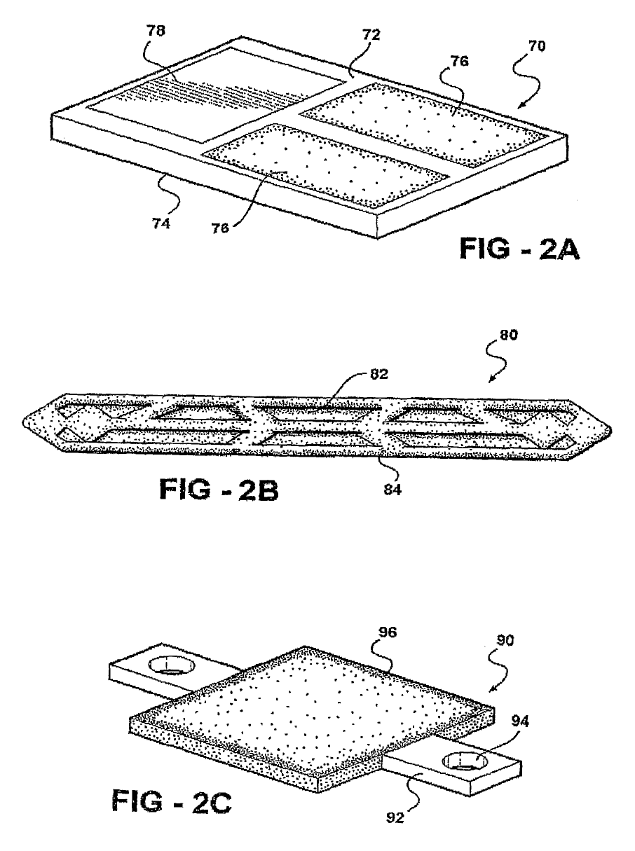

Turning now to FIG. 2A, another embodiment is shown of an encapsulated member flat panel test plaque, generally denoted by numeral 70, including a topside 72 to the flat panel, with an underside 74 to the flat panel. In this embodiment, various materials have been incorporated into the surface and the interior of flat panel 70, and are generally preferably dissimilar materials in order to achieve various properties along the length and breadth of any encapsulated member manufactured in accordance to the present invention. A first dissimilar material 76 is shown on the surface of one of the panels, and may include a different type of material than is generally used across the surface of flat panel 70. A second dissimilar material 78 is incorporated into the surface at the other end of the flat panel. These dissimilar materials 76 and 78 may be incorporated into the mold when it is open and masked off to include only these materials to be heated against the mold, before the molds are closed to encapsulate the interior component. It may therefore be desired to have a powdered paint or a magnetic surface or an electrically insulating area, or any other such desired material property across the surface. In practice, the heated mold may be masked off and only the material desired can be melted against that portion of the interior surface of the heated mold. Thereafter, the mask may be removed and another material may be utilized on the surface of flat panel 70.

FIG. 2B shows an encapsulated cross member, generally denoted by numeral 80, designed to be part of a car chassis. Conventionally, the chassis cross member is usually a heavy gauge piece of sheet metal that is bent into a convoluted channel shape. It is mounted onto the bottom of the chassis, and keeps the transmission firmly secured at the end where the drive shaft begins. On some cars, the cross member is removable; on other cars, it is part of the body shell. The present invention may reduce substantial weight of a chassis cross member by replacing heavy metals with encapsulated light metals such as magnesium, aluminum, or/and alloys of these metals. In this embodiment, the interior component of encapsulated cross member 80 is a preformed magnesium component shaped to a desired structure. The encapsulated cross member 80 includes several apertures 82, it is formed when the preformed magnesium component is shaped. The preformed magnesium component may be used as structural member for the required strength and stiffness to the chassis cross member, while the exterior encapsulating plastic skin 84 provides support to prevent buckling and the necessary protection for chassis cross member surface from abrasion, impact, chemicals and corrosion without adding significant weight. Exterior plastic skin 84 of the encapsulated cross member 80 casts only the necessary surface of the preformed magnesium component, and will not block the apertures 82 with extra plastics. Therefore, the present invention provides greater design flexibility.

FIG. 2C shows a encapsulated mounting member, generally denoted by numeral 90. The encapsulated mounting member 90 includes a interior mounting component 92 with at least one aperture 94 for mounting and a exterior plastic skin 96. The interior mounting component 92 may be made of any suitable material; preferably it is made of metal. The encapsulating exterior skin 96 may cover the entire body of the interior mounting component 92 or cover only partial portion of it as shown in FIG. 2C. Partial encapsulation of the mounting component 92 will preserve metal properties such as high ductility and conduction of electricity and heat.

The encapsulated members of the present invention combine the strength of metals and plastics. The metal may provide as structural member for the required strength and stiffness to the structure, while the plastic provides the necessary support to prevent buckling, enhances strength, protect encapsulated member surface from abrasion, impact, chemicals and corrosion without adding significant weight. The present invention combines the inherent strengths of each material and manufacturing process; offers significant weight reduction; improves structural strength and component integration; and increases cost efficiencies, and greater design flexibility.

Although a single mold can produce a single piece of a plastic article merely by contacting the heated mold with a reservoir of plastic, it is further envisioned that a sandwich-type of composite material can be made by first making both male and female mold portions, forming “skins” on each of the molds, and then placing any type of “sandwich filler” material in between the two skins in a clamshell-type configuration with a filler or foaming expandable plastic in between. Generally, the expandable foam is activated by the residual heat from the molds.

In the event that male and female mold skins are utilized, any type of interior components or desired preforms may be sandwiched between the two skins and may be fully surrounded by the filler or expandable foam plastic to form an encapsulated member. For example, to add structural strength, it is envisioned that a whole host of reinforcements may be used. Especially strong is a metal mesh inserted between the two skins along with expandable plastic material which will attach the two skins to one another, while embedding the steel mesh there between. In yet another reinforcement embodiment, a sheet of polyamide fibers (e.g., KEVLAR® polyamide fibers) can be introduced between the skins and within the foamed plastic in order to provide a bulletproof door, for example, for airplane cockpit door applications. KEVLAR® is a registered trademark of DuPont Corporation of Wilmington, Del. Small individual wire mesh cones may be utilized for superior strength. Furthermore, crumbed tire may be incorporated into the center of the male and female mold skins in order to make it nailable for modular housing applications. Other reinforcement material may be selected from glass fibers, carbon fibers, boron fibers, metal flakes, and mixtures thereof. The reinforcing materials, and the glass fibers in particular, may have sizings on their surfaces to improve miscibility and/or adhesion to the plastics into which they are incorporated, as is known to the skilled artisan. If it is desired that the plastic article needs to be cut to shape, then the insert/reinforcement material sandwiched between the male and female mold skins may be made of small particles such that the article can be machined or cut.

Any of the interior components, desired preforms, inserts or reinforcements may be pre-treated to aid in the adhesion between layers, or to help prevent the insert or reinforcement from delaminating inside the encapsulation by cutting or shearing the foamed plastic that encases it, when under load. Such pre-treatments may include powder-coating a wire mesh with a compatible epoxy resin; or applying a sulfonating technique to individual particulates, such as tire crumb or other recycled materials, to enhance their adhesion; or plating and/or depositing certain metallic or non-metallic coatings onto the insert/reinforcement to enhance adhesion; or even structural treatments such as sandblasting, surface grinding, tackifying with chemical treatments or the like; or the application of heat treatments such as annealing and/or quenching to change the surface properties; or the application of magnetic fields; or by forming an easy-to-adhere-to surface by forming or etching the insert/reinforcement to resemble reticulated foam by increasing the surface area.

Furthermore, it is envisioned by the present inventors that multiple layer structures can be formed by first making a male or female mold skin, followed by making a second male or female mold skin, and then a third complementary and mating male or female mold section can be formed. Each of these forms can be placed one on top of the other and heated with a filler material or foamable plastic in between, or with other materials which will melt and attach the skins altogether.

Because the present process is done at a relatively low temperature, i.e. slightly higher than that of the melting point of the plastic particulate being contacted with the heated mold, the mold itself will last a long time. In conventional injection molding, the plastic must be elevated in temperature to over 1,000° F., and commonly up to 1,500° F. in the worm screw before it is injected into the mold. With the combined effect of these high temperatures and high pressures used, the mold rapidly degrades. Also, the present invention is done in ambient pressure, rather than the many tons of pressure required by injection molding machines. Of special interest to all manufacturers, is the fact that the molds which can be used in the present invention may be made of pure aluminum or inexpensive and recyclable aluminum alloys such as kirksite which are cheap to make and easy to machine. Because of the low temperature and low pressure application, the molds do not degrade as they do in injection molding. For example, a mold used to make an entire truck bed box would cost more than a million dollars for a typical injection mold production mold, while the present invention mold can be made for less than one-tenth of that price. This factor alone will encourage new products because of the lower necessary up-front costs.

In that regard, the following description of the general article construction is disclosed, and will be followed by the various process embodiments for manufacturing articles in accordance with the present invention, and then by specific embodiments for various applications. Of course, the scope of the present invention is not to be limited to the specific applications promulgated herewith, but rather will be limited by the claims when they are filed.

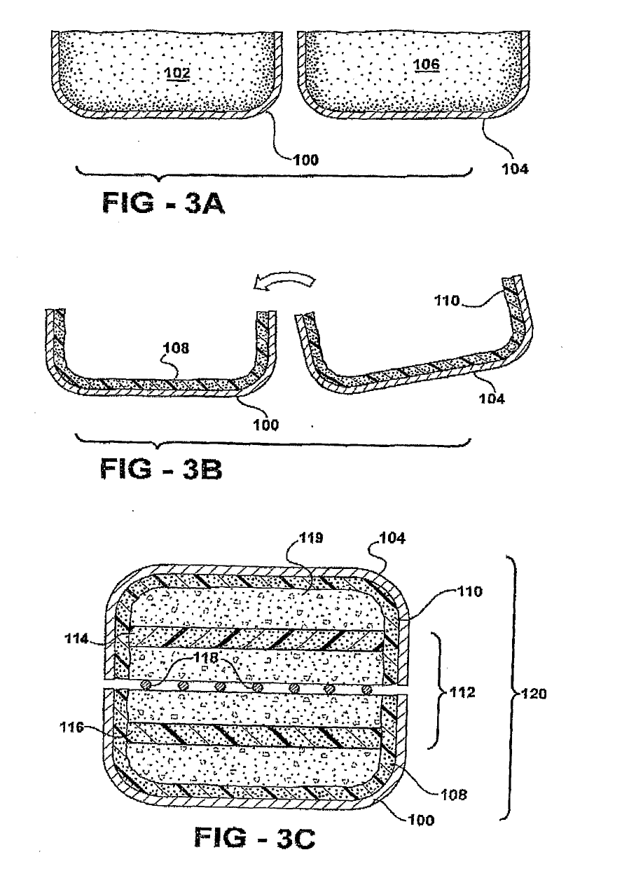

As seen in FIGS. 3A-3C, there is shown a method of making a double skinned article, such as a pick-up truck bed box or housing module. Heated male mold 100 and female mold 104 are shown filled with plastic particulate matter 102 and 106 respectively. A first skin 108 is formed on the inside of male mold 100 and a second skin 110 is formed on the inside of female mold 104. Thereafter, the excess plastic particulates are removed by dumping or vacuuming, an expandable foam is distributed between the molds. The male mold may be placed within the female mold, or vise versa, and held at a predetermined distance apart so that the expandable plastic can be expanded between the two molds with their respective skins. The expandable plastic can “foam up” until it fills the cavity created by the two mold pieces. If the molds are secured to one another while leaving a one inch (1″) space between them, a one inch expansion will occur.

If, on the other hand, the mold pieces are facing each other to maintain six inches (6″) apart as shown in FIG. 3C, then the expansion layer will be six inches thick. As described above, any desired preforms or metal foams may be placed between the two molds, along with the expandable plastic, before they are placed together and the heat from the molds heat up the expandable foamable plastic to make it expand. Once the expandable plastic sets, it will encapsulate the preforms or metal foams within the skins and will secure the preforms or metal foams from any side-to-side motion, especially if the preforms or metal foams has, any surface contour or porosity so that the expandable plastic will surround the insert and hold it in place. The inventors have found that gravity alone is a sufficient force to hold the two molds together, held apart by spacers, and the residual heat from the mold is sufficient to kick off the expandable foam plastic such that it will expand.

FIG. 3C shows the resulted, encapsulated reinforced member, generally denoted by numeral 120, located within an open mold having skins thereon, and being filled in between foamable material. As described above, first skin 108 is formed on the inside of male mold 100 and the second skin 110 is formed on the inside of female mold 104. Foamable material 119 is placed into male and female mold pieces 100 and 104 on top of the first skin 108 and second skin 110. And then move the mold pieces 100 and 104 to face each other to enclose a preformed encapsulated member 112 as described in FIG. 1C. A double skinned encapsulated member will then be formed when the residual heat from the mold is sufficient to kick off the expandable foam plastic such that it will expand.

In the event of using this technology for a pick-up truck bed box, it is envisioned that the wiring harness can be embedded into the truck bed box itself, with the electrical connectors extending outwardly from the box, ready to be plugged into the electrical connections coming out of the back of the truck. The wiring components can be laid onto the male mold before the female mold is laid over top of it, and before the expandable plastic is subjected to heat, causing it to expand and encapsulate the wiring components right into the truck bed box itself, while allowing the connectors to hang loose, ready to be assembled into the truck. In the alternative, a conduit could be embedded into the plastic truck box to allow for wiring to be fed therethrough. The outer skins of the truck bed box can be molded to perfection with color so that painting of the truck bed box is unnecessary. Other applications for the present technology will be discussed below, and the appropriate configuration and insert/reinforcement for each application will be discussed.

The inventors also envision that the mold itself can be made of an electrically conductive material. This electrically conductive mold can be charged to attract fine plastic particles, melt them on the surface, and form a thin-skinned part to be removed after cooling. This is also suitable for use with electrostatic powder coat paints. For example, a mold can be electrically charged and sprayed with a releasable powder coat paint resin first, then heated and cured while using the curing heat to heat the mold and then contacting with plastic particulates which will adhere to the paint, to a desired thickness. Upon cooling, the newly formed article will “pop” out of the mold with a freshly cured paint job thereon.

### II. General Article Construction

In addition to the above described embodiments with descriptions of plastic outer skins, the present invention also encompasses any other moldable material for the inner and outer skins, including, but not limited to, melted powdered metallic skins, such as aluminum, or other meltable metals; ceramics that may be slip cast into a mold or ceramic powders that may be fused together with a resin or binding agent as the outer skins. A combination of the skins may also be useful, such as a metallic skin on one side with a plastic skin on the other side of the structure. Furthermore, one side may have a ceramic exterior skin, while the other side may be a metallic skin.

Moreover, portions of the mold may be covered by various powdered materials which may be spread over a portion of the heated mold at a first temperature, i.e. 640° to 660° C., which is then followed by allowing removal of any excess powdered metal, is such as aluminum or magnesium. Thereafter, when the mold has had a chance to cool to about 450 F., then a powdered plastic material can be put over the portion of the mold that needed to have a plastic skin. This shall melt the plastic and combine the two materials at that juncture point to form a metal/plastic composite skin of sorts. If the melted metal is left with a rough edge, then the plastic skin will be able to fill in the rough spot, and form a more or less composite area in the outer skin. After the plastic has melted to a desired thickness, the excess plastic powder can then be removed, thereby forming a composite outer skin of metal and plastic.

The same concept can be employed for a combination plastic, metal and ceramic outer skin, with portions of each of the desired materials may be placed into the heated mold when and where appropriate. Since each of these materials can be selected for their desired properties, and since the various temperatures of the mold as it cools may be useful for different melting point materials, the succession of the materials can be easily calculated depending upon their melting temperatures. For example, aluminum powder can be placed in certain areas of the mold that has been heated to a first elevated temperature, i.e. above 660° C. in order to make an aluminum skin in at least a portion of the mold. Then, once the mold has been emptied of the excess aluminum powder, either by tipping the mold over and allowing gravity to remove the excess, or by vacuuming the excess powder, or by any other feasible method, it can be allowed to cool to a certain degree.

Once the cooling process has progressed sufficiently to achieve a second desired temperature, i.e. the temperature just above the melting point of the second material, i.e. 450° F. for polyurethane, then powdered polyurethane can be placed on the mold in the desired places. On the other hand, ceramic powder could be mixed in with the aluminum powder to have the aluminum melt and surround the ceramic powder particles, thereby making a cermet outer skin of the ceramic and aluminum.

Such ceramics may include, but are not limited to, ceramics selected from the group consisting of nitrides, carbides, borides, or any other ceramic, but may be selected from the group of silicon nitride, silicon carbide, alumina, boron carbide, tungsten carbide, and other carbides, nitrides and oxides of various metals to be chosen for their various properties, whether in powder, whisker, low aspect talc form, or any other form which can be incorporated into the skin, either by itself if it can be slip casted, or extruded, or along with a resin in order to be incorporated into the bulk of the out skin material.

Further, the outer skin may incorporate any type of filler material which may be anything with a higher melting temperature than the selected material for the outer skin. Additional materials which may be used for the outer skin may be selected from particulate materials including clays such as kaolin, cordierite, mullite; metal flakes such as iron filings, steel chips, magnetic filings, magnetic particles and various other surface enhancing metal particulates; pulverized road construction particulates including stone chips, crushed slag, crushed concrete, cracked and crushed heavy road tars, and the like; crumbed rubber tires, densified foam chips, recycled materials to be used as filler or as property enhancers, or any combination of the abovedescribed materials.

Of course, other metals could be mixed either homogeneously or non-homogeneously with the aluminum powder to form a skin of an alloy of metals, such as magnesium. Once these outer skins are made, by processes described hereinbelow with reference to the various drawings, then the inner layers, preforms, reinforcements and are formed within the outer skins to produce useful manufactured articles. In that regard, the following specific embodiments will teach the methods and apparatus used to make the novel new products.

### A. Metal Outer Skin With Formed Plastic Interior

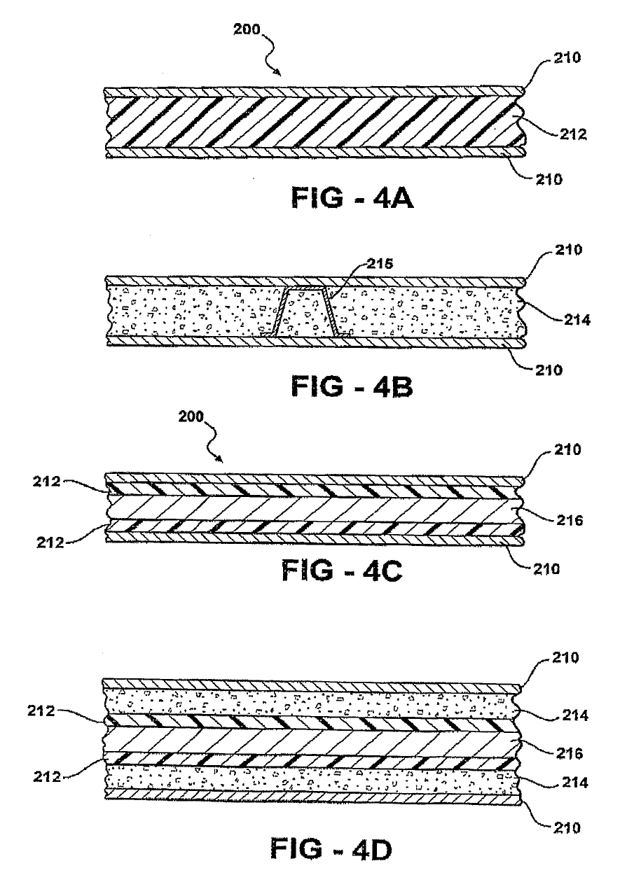

FIG. 4A shows an embodiment of the present invention that describes a composite structure generally denoted by the numeral 200 in which multiple outer skin composite of metal 210 may include a formed plastic interior 212 therein. This composite structure 200 may include a pair of complementary molded metallic skins 210 having a plastic material in the center between the skins. This structure may be made by several steps, beginning with first heating a mold, such as an airplane wing mold having a higher melting temperature than the metal being formed therein, and thereafter forming the plastic inside. For example, if an aluminum outer skin covering a plastic core is desired for an airplane wing configuration, it would be feasible to make a stainless steel mold section that could be heated to a temperature above the melting point of the aluminum powder being used for the outer skin. First the aluminum skin would be formed, and then the plastic core would be formed.

The mold would be heated to about a temperature of from about 660° C. first to melt aluminum particulate, such as a powder, which would be placed in contact with the heated mold. When the desired thickness of the aluminum skin 210 would be achieved, i.e. about 1 to 10 minutes per desired millimeter of skin, then the excess powdered aluminum would be removed as described above, thereby forming an aluminum skin in the mold. The mold could then be allowed to cool to a second cooler temperature of about 450° F. and a powdered polyurethane material could be distributed over the areas desired and allowed to melt until a desired thickness of, for example, a polyurethane plastic 212 has been achieved, i.e. about 1 to 5 minutes per desired millimeter of thickness, then the excess powdered polyurethane would be removed as described above, thereby forming a polyurethane skin in the mold in the areas that it was desired. Otherwise, the particulate plastic could just be placed in the mold in a sufficient amount and then allowed to remain, thereby forming the composite structure 200. Alternatively, a preform could be placed in the open mold after the metal skins have been formed, and the two mold halves would be held together until the outer skin melted together to seal and encapsulate the preform. Thereafter, these two composite skins could be re-melted to form a desired skin pattern, or left alone.

### B. Metal Outer Skin With Foamed Plastic Interior

FIG. 4B shows a cutaway view of still another embodiment of a new composite structure in which a pair of molded metallic skins 210 has a foamed material 214 in the center between the skins, where a foamed material is placed into the mold after the molded metallic skins are made to form a foam core with a metallic skin encapsulating it. Again, the metallic skins 210 would be made first, and then when the mold cooled, it could be followed by placing a small amount of a particulate plastic material, with a blowing agent therein, into the mold cavity, while it was still open, and then closing the heated molds so that the residual heat from the previous operation would “kick off” the foam to rise up and fill the cavity between the metallic skins. Although any suitable blowing agent may be used, a description of suitable blowing agent may be found in copending PCT. Patent Application No. PCT/US02/03298, which is incorporated herein in its entirety by reference.

A reinforcement 215 of any size or shape may be placed into the mold after the skins 210 have been formed. Reinforcement 215 may be held in place by the foamed polyurethane 214 after the foam has been “kicked off” to surround and encapsulate the reinforcement. The reinforcement may be made of any material, so long as it has a melting temperature higher than the foaming temperature of the foamed core material. Typical examples of a reinforcement may include a steel mesh for strength, a pre-cut sheet of Kevlar for flexibility, a strengthening cone made of plastic, or metal, or any other type of reinforcement may be utilized.

### C. Metal Outer Skin With Interior Plastic Encapsulated Metal Preform

FIG. 4C shows a side elevational cutaway view of yet another embodiment of a new composite structure having a pair of molded metallic skins with an interior plastic encapsulated metallic preform 216 in the center. The encapsulated metallic preform may be encapsulated already in a plastic 212, as discussed previously with reference to FIG. 1 through 3. This figure shows a cutaway view of the new composite structure in which a pair of molded metallic skins 210 has an interior plastic encapsulated metallic preform 216 in the center between the skins. This configuration is formed where an interior plastic encapsulated metallic preform material is placed into the mold after the molded metallic skins are made to form a composite structure with a metallic skin encapsulating it. This embodiment may be important in the airline industry where a magnesium preform may be encapsulated first with a polyurethane, but then an aluminum skin encapsulation would be desired in order to be used on the exterior of the airplane. The metallic skin would protect the plastic that is protecting the magnesium preform core. Overall, the weight reduction could be an advantage.

### D. Metal Outer Skin With Interior Plastic Encapsulated Metal Preform in a Foamed Core

FIG. 4D shows a side elevational cutaway view of another further multi-layer structure embodiment of a pair of molded metallic skins 210 having a multi-layer structure therebetween, including a plastic encapsulated metallic preform 216 in the center between the skins, in addition to a foamed material 214 on at least one side of the preform. Again, the outer skins would be formed first, the encapsulated preform would be placed in the mold along with a foaming material, and the foaming would rise up and surround the already encapsulated preform. This embodiment might find great utility within the aerospace and aeronautical industries.

### E. Ceramic Outer Skin With Formed Plastic Interior

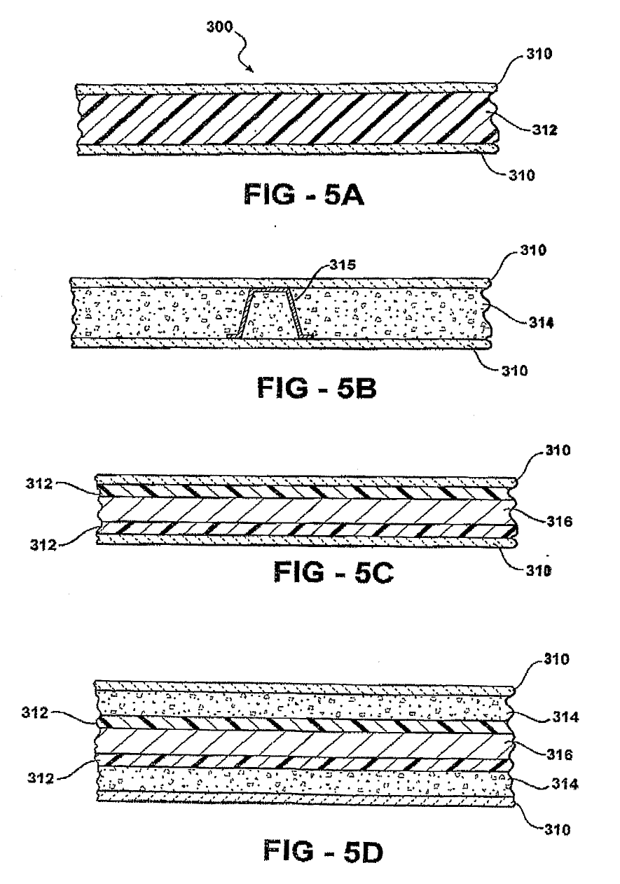

FIG. 5A shows yet another embodiment of a pair of complementary molded skins having a plastic material in the center between the skins, only now the outer skins will be made of a ceramic material. In this illustration, the composite structure is generally denoted by the numeral 300, and includes a pair of ceramic skins 310 and incorporates a plastic core material 312. The ceramic material may be any suitable ceramic material, and it may be slip cast into the mold or ceramic powder pressed into the desired shape. It is envisioned that the ceramic layer can be made against a heatable metallic mold, and after the ceramic skin is formed, the heatable mold can be heated to help form the plastic core 312. It is well known in the art to slip cast a ceramic material into a desired shape, and a green ceramic is generally acceptable for many applications. The plastic core material 312 may add resiliency and stability to the ceramic skins.

### F. Ceramic Outer Skin With Foamed Plastic Interior

FIG. 5B shows a cutaway view of yet another embodiment of a new composite structure in which a pair of molded ceramic skins 310 has a foamed material 314 in the center between the skins, where a foamed material is placed into the mold after the molded ceramic skins are made to form a foam core with a ceramic skin encapsulating it. Again, the ceramic skins 310 would be made first, and then when the mold cooled, it could be followed by placing a small amount of a particulate plastic material, with a blowing agent therein, into the mold cavity, while it was still open, and then closing the heated molds so that the residual heat from the previous operation would “kick off” the foam to rise up and fill the cavity between the metallic skins. Although any suitable blowing agent may be used, a description of suitable blowing agent may again be found in copending PCT. Patent Application No. PCT/US02/03298, which is incorporated herein in its entirety by reference.

A reinforcement 315 of any size or shape may be placed into the mold after the skins 310 have been formed. Reinforcement 315 may be held in place by the foamed polyurethane 314 after the foam has been “kicked off” to surround and encapsulate the reinforcement. The reinforcement may be made of any material, so long as it has a melting temperature higher than the foaming temperature of the foamed core material. Typical examples of a reinforcement for this ceramic configuration may include sheets of carbon fiber, any mesh for brittle resistance or strength, a strengthening cone made of plastic, or metal, or any other type of reinforcement may be utilized.

### G. Ceramic Outer Skin With Interior Plastic Encapsulated Metal Preform

FIG. 5C shows a side elevational cutaway view of yet another embodiment of a new composite structure having a pair of molded ceramic skins with an interior plastic encapsulated metallic preform 316 in the center. Similar to the embodiment shown in FIG. 4C, the encapsulated metallic preform may be already encapsulated in a plastic 312, as discussed previously with reference to FIGS. 1 through 3 and 4C. This figure shows a cutaway view of the new composite structure in which a pair of molded ceramic skins 310 has an interior plastic encapsulated metallic preform 316 in the center between the ceramic skins. This configuration is formed where an interior plastic encapsulated metallic preform material is placed into the mold after the molded ceramic skins 310 are made to form a composite structure with a ceramic skin encapsulating it.

### H. Ceramic Outer Skin With Interior Plastic Encapsulated Metal Preform in a Foamed Core

Like FIG. 4D, FIG. 5D shows a side elevational cutaway view of yet another embodiment of a new composite structure having a pair of molded ceramic skins with an interior plastic encapsulated metallic preform 316 in the center. Similar to the embodiment shown in FIG. 4D, the encapsulated metallic preform may be already encapsulated in a plastic 312, thereby forming a multi-layer structure therebetween, including a plastic encapsulated metallic preform in the center between the skins, in addition to a foamed material on at least one side of the preform.

Of course, the present invention also envisions that any of the above described layers may be substituted for each other, or may be put in combination with each other. In other words, a resulting product may incorporate one metallic outer skin, one ceramic outer skin, some foam in the middle surrounding a plastic encapsulated metallic preform, along with a reinforcement throughout the length of the article. Or, the first skin might be part metal and part ceramic and the second skin could be all plastic, but using different plastics on different regions of the mold. Or, the first outer skin may be plastic and the other outer skin could be ceramic with just some foam and a reinforcement in the center. The configuration of each of the layers will depend on the desired end result. All of the possible combinations are to be protected by this patent application.

### III. Basic Manufacture of the Invention

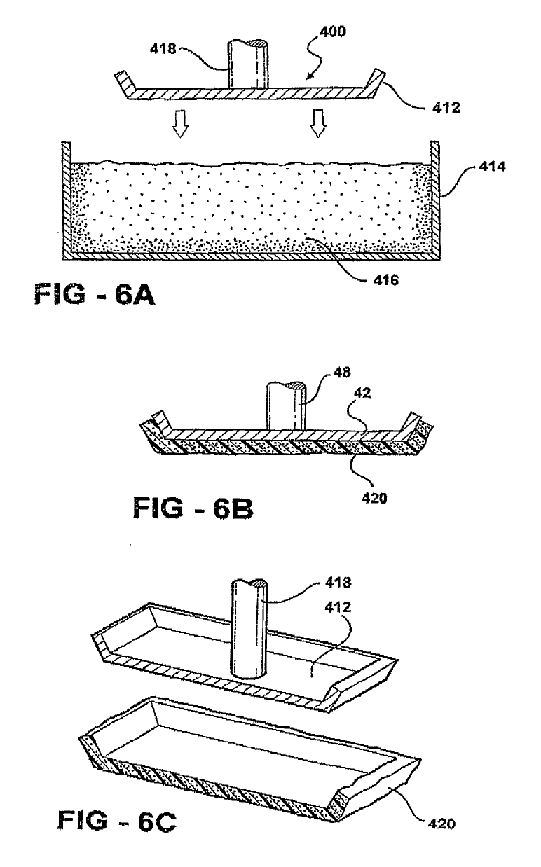

With reference to FIGS. 6a-6c, there is shown an illustration of a very general article and the respective process for manufacturing articles in accordance with the present invention, generally denoted by the numeral 400. Mold 412 is shown as being formed to make a plate article with raised edges. Mold 412 is to be heated to an elevated temperature of greater than the melting point of the plastic particulates 416 held within container 414. As seen in FIG. 6b, an article 420 is formed once heated mold 412 has contacted plastic particulate 416 for a sufficiently long time to achieve the desired thickness of article. Thereafter, the heated mold can be purposely cooled, or allowed to cool, as illustrated in FIG. 1c and article 420 can be easily removed from mold 412. If heating and cooling lines are used in carrier 418 or in mold 412 itself, then cooling fluids could be run through the lines, which would automatically contract the mold as it got cooler, pulling mold 412 away from formed article 420, which would remain relatively hot when compared to a cooler mold.

Generally, the plastic particulate material may be powder, pellets, resin, or any other form of plastic, including sheets or blocks, and they may either be at room temperature, or at an elevated temperature, depending upon the application as will be seen further hereinbelow. Preferred plastics include HDPE, LDPE, polyethylene, polypropylene, polyurethane, or other widely used plastic resins. Environmentally friendly plastics, such as polylactic acid may also be utilized, or other plastics made from renewable sources including the plastic made by Cargill Dow from corn and its husks, or plastics made from the hemp plant. Mold 412 may be heated in a number of ways, including, but not limited to, heater lines in the mold itself for conducting hot water, oil or gas; a heat dissipative material attached to the mold itself or a backplate on the mold, such as mold carrier 418 of FIGS. 6a-6c; the mold might be heated in an oven to a predetermined temperature prior to contacting the plastic; the mold might be heated with heater torches or direct flame application; the mold might be heated with Infra-Red lamps or other light energy; the mold might be heated with microwave energy or other radio frequency energy; the mold might be heated with plasma heat generated by a plasma generator; the mold might be heated by thermoelectric devices in or on the mold itself; the mold might be heated uniformly over the surface to achieve a uniform coating of melted plastic or it might be selectively heated over portions of the surface so that multiple materials can be sequentially melted next to one another or spaced apart; the mold may be heated to a first temperature and contacted with a first material, and then may be heated or cooled to a second temperature to melt a second material; or the mold may be heated by any conventional means for heating a mold. Furthermore, combinations of these techniques may prove to be helpful, including heating the mold in an oven while also heating the mold with microwave or other radio frequency energy.

It is also envisioned that the plastic particulate material may be heated to a near melting point temperature before contacting it with a heated mold. The plastic particulate may be held in a container waiting to receive the mold, or it may find utility in a heated or unheated fluidized bed of the plastic particulate. Thus, submerging the heated mold into the fluidized bed would contact the heated mold with the fluidized particulates. The fluidized bed could be fluidized with gases other than air such as nitrogen, helium, sulfur-containing gases, etc., in order to impart a surface effect once the plastic melts and sticks to the heated mold. If a different gas was utilized, any number of surface effects could be experienced, which might help with adhesion of later layers, or could help with “sealing” the plastic once it was formed into an appropriate shape. Possible gas applications would include the use of a sulfur-containing gas to effect a sulfonation of the plastic in order to prevent chemical migration through the plastic, the use of an inert gas such as argon or neon to cause a peening, annealing or quenching effect of the plastic without effecting any surface chemistry reactions at such elevated temperatures; a nitrogen-containing gas to prevent oxidation of the surface; a fluoride or other halogen-containing gas to effect electrical conductivity changes on the surface of the resultant article; hydrogen or helium gas may be used to encourage thermal transfers through the plastic if the article is a relatively thick or bulky piece; or various acidic or basic gas compositions to impart a particular predetermined pH on the surface of the article.

Moreover, it is also envisioned that an initial layer of viscous plastic may be imparted on the bare surface of the heated mold 412 by contacting with a finely ground powdered plastic first to form a first “sticky” surface prior to contacting with heavier plastic particulates in order to provide an adhesion layer for subsequent contact with other, possibly less expensive plastics. This viscous layer may be accomplished by various methods, including contacting the mold with a finely powdered plastic first, or by using heated plastic particulates, or by contacting heated, finely ground plastic material combined. In addition, a different type of plastic may first be used, such as one that exhibits greater flow and adhesion with the mold material, followed by a bulkier particulate plastic material.

For certain applications, it may be advantageous for the adhesion of a first plastic, one that is relatively expensive, to be followed up with at least one more layer of inexpensive plastic. This way, an article can have the desired strength from a bulk or recycled plastic, while the skin can be made of an expensive material with decorative features or colors. Color can be blended right into the underlying materials so that any scratches or minor surface blemishes will be indistinguishable from the surface, alleviating the necessity for repairs. The inner layer(s) of material may also be selected to impart strength, heat insulation, fire retardation, energy dispersion qualities such as impact or bullet resistance, or filling with various materials to achieve certain other qualities, such as the inclusion of crumbed tire to give a spongy center, or one that can be easily cut, scored or nailed. Insulation materials may be included for modular housing panels.

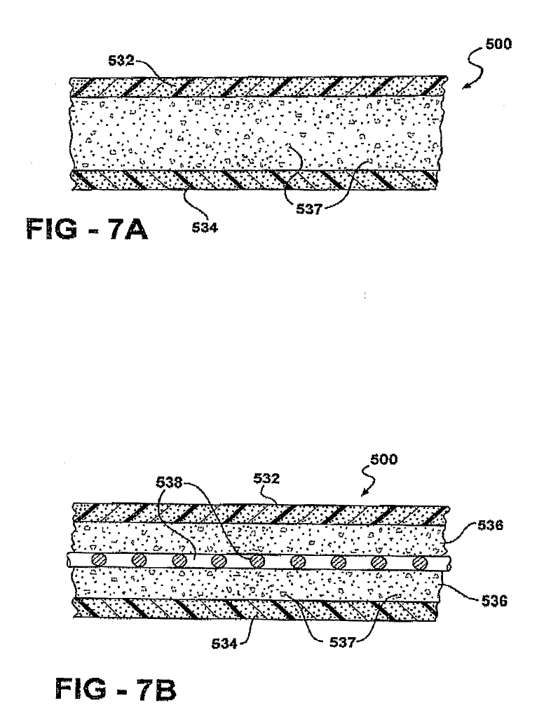

Looking next to FIG. 7a, there is shown a multilayer structure made in accordance with a preferred embodiment of the present invention which is generally denoted by the numeral 500. First and second plastic skins 532 and 534, respectively, are individually formed on separate heated complementary male and female molds, and then a foamable or expandable plastic 536 may be placed between the two skins and heated to expand and adhere to the two plastic skins, forming a lightweight, but very strong, article suitable for many applications. Air pockets 537 are formed as a consequence of the expansion of expandable plastic 536, available from numerous plastic resin suppliers. An especially desirable expandable plastic is available from Equistar Corporation of Cincinnati, Ohio.

As will be discussed below, any number of porous sheets, wire meshes, or other inserts and/or reinforcements can be loaded onto the first male skin mold prior to the placement of the foamable or expandable plastic and prior to the second female skin mold being put into place over the first skin mold. Generally, it is most advantageous for the expandable or foamable plastic to be activated by the heat which is imparted by the two heated male and female molds as they are held together in a spaced apart relation with the foamable plastic and/or any desired reinforcements in between. Once the expandable plastic is expanded due to the heat imparted from the first and second molds, any insert or reinforcement which was placed between the molds is encapsulated and sandwiched into the article 500 structure. Looking now to FIG. 7b, there is shown again a multi-layer structure generally denoted by numeral 500 having a reinforcing wire mesh 538 shown embedded and encapsulated within expanded plastic 536, and between first and second plastic skins 532 and 534.

Numerous other inserts and/or reinforcements may be encapsulated between the top and bottom skins, including, but not limited to, wire meshes for strength, metal bars and mounting pieces which are to extend outwardly from the skin to facilitate mounting to other fixtures, Kevlar material may be sandwiched to render the piece bulletproof, such as for airplane cockpit doors, or fire retardant materials may be used as sheets to prevent burn-through. Other material properties can be exhibited by inclusion into the plastic skins of magnetic materials, ceramic powders or whiskers for heat and flame resistance, chemically resistant materials, thermoelectric materials, colored pigments, tough plastics for impact resistance and energy dispersion, anti-microbial chemicals on the surface, enzymes for different purposes, among others.

Virtually anything can be encapsulated in the expandable plastic, and it will be kept encapsulated until a total rupture of the multilayer structure occurs. The only restriction is that the insert or reinforcement will experience an elevated temperature due to the heated molds which can melt or deform certain types of material. The inserts can be entirely encapsulated, or only partially encapsulated such that portions of the insert can extend outwardly from the plastic article. This will enable the plastic article to have mounting bars encapsulated by the plastic, with mounting bar portions extending outside the article to be mounted on, for example, a metal truck chassis frame by bolting or otherwise fastening the mounting bars to the chassis. Furthermore, the insert may be a heat resistant or insulative piece which can contact a metal frame, without dissipating the heat to the plastic article, and alleviating a fear of melting.

The basic method of making a double skinned article, such as a pick-up truck bed box or housing module is made by placing a heated male mold into a box containing plastic powder or pellets or the plastic particulates may be blown into the box after the mold is in the box. A skin forms on top of the mold, as shown in FIG. 3b. The female mold is shown filled with plastic particulate matter, and a second skin is formed on the inside of the female mold. Thereafter, the excess plastic particulates are removed by dumping or vacuuming, an expandable foam plastic material is distributed between the molds, and the male mold is placed within the female mold, or vise versa, and held at a predetermined distance apart so that the expandable plastic can be expanded between the two molds with their respective skins. The expandable plastic can “foam up” until it fills the cavity created by the two mold pieces. If the molds are secured to one another while leaving a one inch (1″) space between them, a one inch expansion will occur.

If, on the other hand, the mold pieces are maintained six inches (6″) apart, then the expansion layer will be six inches thick. As described above, any desired inserts and/or reinforcements may be placed between the two molds, along with the expandable plastic, before they are placed together and the heat from the molds heat up the expandable foamable plastic to make it expand. Once the expandable plastic sets, it will encapsulate the insert/reinforcement within the skins and will secure the insert/reinforcement from any side-to-side motion, especially if the insert/reinforcement has any surface contour or porosity so that the expandable plastic will surround the insert and hold it in place. The inventors have found that gravity alone is a sufficient force to hold the two molds together, held apart by spacers, and the residual heat from the mold is sufficient to kick off the expandable foam plastic such that it will expand.

The inventors also envision that the mold itself can be made of an electrically conductive material. This electrically conductive mold can be charged to attract fine plastic particles, melt them on the surface, and form a thin-skinned part to be removed after cooling. This is also suitable for use with electrostatic powder coat paints. For example, a mold can be electrically charged and sprayed with a releasable powder coat paint resin first, then heated and cured while using the curing heat to heat the mold and then contacting with plastic particulates which will adhere to the paint, to a desired thickness. Upon cooling, the newly formed article will “pop” out of the mold with a freshly cured paint job thereon.

It is also envisioned by the present inventors that varying materials can be used across the surface, or in the interior of a formed article, as shown in FIG. 2A, having multiple materials for the top and bottom skins, and having various materials across the surface. This is accomplished by either heating various portions of the mold and contacting with different materials, or by distributing different materials on various surfaces of the mold. Heater lines can be incorporated into the mold in separate sections. For instance, the mold could first be heated in the regions of a first area, and then contacted with a first material. Then, the mold would be cooled in those areas, such that it would not melt plastic, although the remainder of the mold, the top skin could be heated so that a second material would be melted against its surface. Likewise with the differing material regions as shown in FIG. 2A, which could remain cool during the first two procedures, but would be heated by itself later on and then contacted with a third material. Other means are envisioned for only heating certain portions of the mold, while controlling the temperature on other portions will have different plastics adhered to those various portions. In addition, once the multi-material layer has been formed, the double skin, or sandwich concept described hereinabove, may come into play in order to form a foamed or reinforced article from a multiple material skin.

Therefore, the various material configurations, layers and inserts/reinforcements envisioned, among others, are described. There are many more configurations which will become apparent as we discuss some of the most pertinent applications hereinbelow.

### III. Various Process Embodiments

Now that we have discussed the actual structure of a portion of an article made in accordance with the present invention, we will turn to the various methods of contacting the powder to the mold, so that the mold can melt the plastic and form it to its ultimate shape.

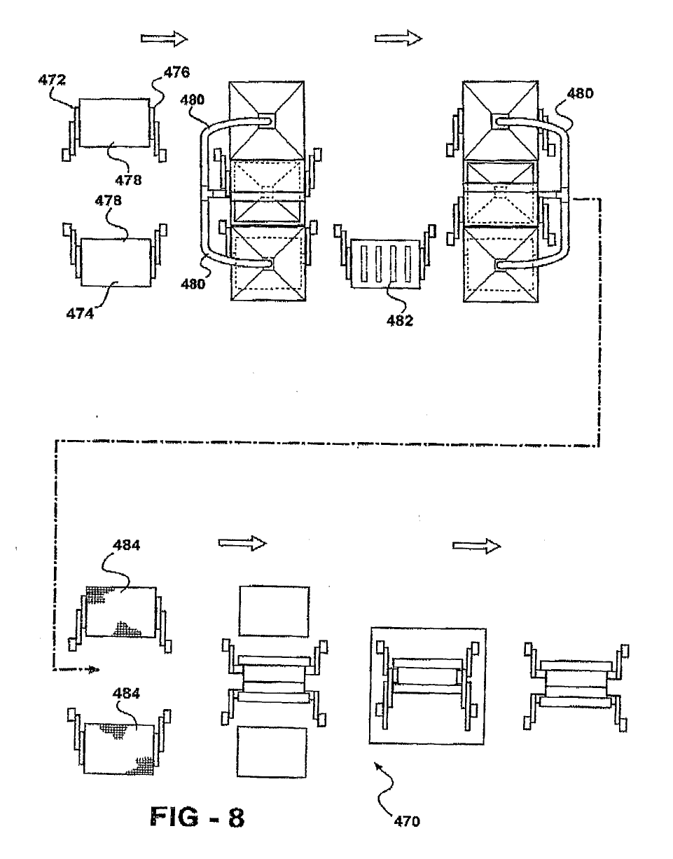

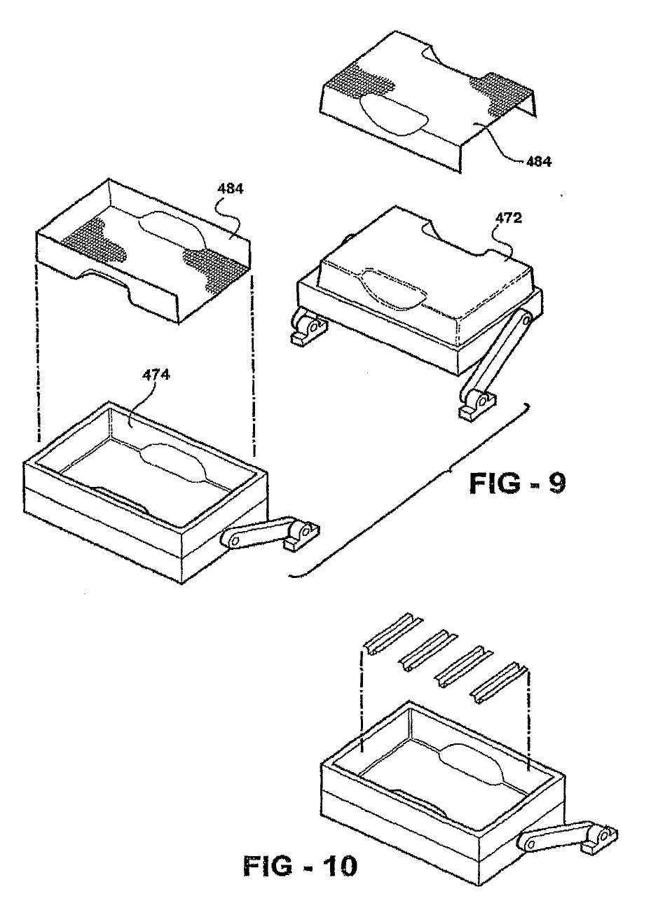

Because one of the most pressing applications is for automotive vehicle components, the basic tip molding process embodiment of the present invention will be discussed now with respect to a polyethylene pick-up truck bed box. As shown in FIG. 8, there is a production method for manufacturing the truck box in accordance with the present invention by using an upper and lower line generally denoted by the numeral 470. There are two molds shown, top and bottom 472 and 474, which represent the male and female molds being covered with melted plastic. The mold is heated by any of the acceptable methods described above, which may include placing in an oven, heating with torches, or by utilizing lines within the mold to contain hot water, oil or gas. In the case of the male mold, the heated mold is placed within a box 476 capable of holding the mold and containing enough plastic particulate to cover the male mold. In the preferred embodiment, while this is going on, the female mold 474 is heated and then filled with the desired plastic particulate 478, and both are allowed to remain in contact with the heated molds for approximately six to eight minutes to achieve a polyethylene truck bed box skin of about three millimeters (3 mm) thick. Then, the molds are either tipped upside down to dust off the excess plastic particulate or the excess is vacuumed out of the box by vacuum hoses 480.

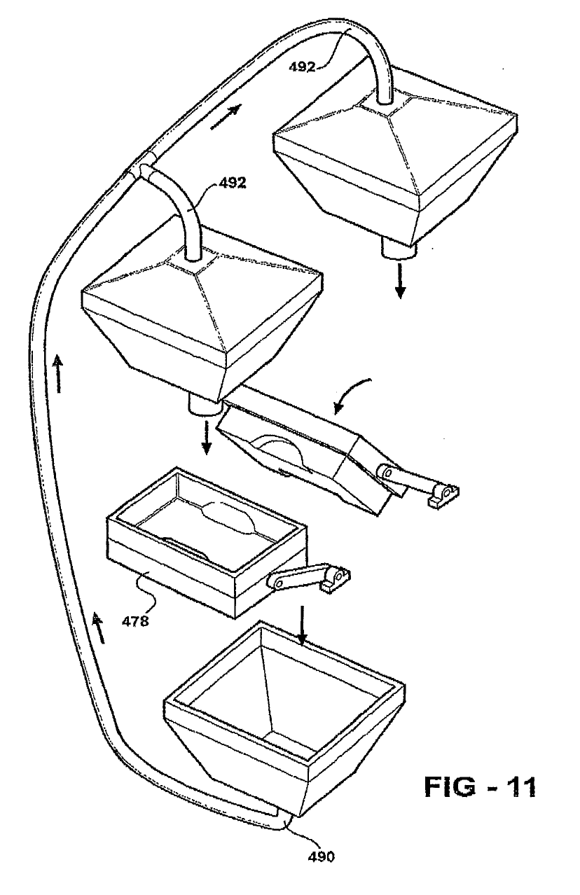

Load rails 482 and a steel wire mesh reinforcement screen 484 is laid onto the top of the male mold as seen in FIG. 9. This wire mesh 484 adds strength and impact resistance to the truck bed box once manufactured. A second wire mesh 484 may be especially useful, and would be placed in the female mold after the excess plastic has been removed. Thus, a set of complementary wire mesh reinforcements 484 can be encapsulated between the double skins. After expandable plastic has been placed on the male mold, the two pieces are then slid into and over one another and the expandable plastic is heated by the residual heat in the hot molds and the expandable plastic “blows” and expands to fill the cavity which has been pre-set by the distance that the male and female molds have been held apart. Then, the mold is cooled, and the part is popped out. In this embodiment, and as shown in FIG. 11, it is envisioned that having a vacuum portal 490 attached to the bottom of the mold will aid in the removal of any loose plastic particulate after the desired thickness has been achieved. As shown in FIG. 10, load rails 482, or any other desirable mounting means, may be lowered into the bottom of the female mold 474. That way there will be steel mounting rails 482 extending from the bottom of the truck bed box, so that mounting will be easily achieved on the truck chassis.

It is also envisioned that there could be vacuum lines 492 and hoses attached to the top and bottom of the mold-containing box or into a cap to be placed over the female mold, and those vacuum lines 492 could also be a means for delivering the plastic particulate 478 onto the top of the mold. Whether male or female, the plastic particulate is allowed to sit for an appropriate resident time, and then vacuumed out from vacuum portals 490 located in the bottom. The plastic particulate materials could be cycled in and out of the molds. For example, vacuum line 492 could be used to blow in the plastic, and then vacuum portal 490 could be used to vacuum out the particulate after it has contacted the heated mold for a sufficient length of time. Or, the same lines could be used to blow in and vacuum the plastic. Further, the vacuum lines could be valved to different bags filled with different materials to achieve a multi-layer article. The particulate would then be the moving part, not the mold. This would allow the heated molds to remain stationary, thereby alleviating the need for tipping over the mold, and would require the same amount of time for filling and emptying the molds. Furthermore, multiple plastic sources would be much simpler due to the ability of picking up any plastic particulates, including different materials for multiple layers, or different regions with varying materials.

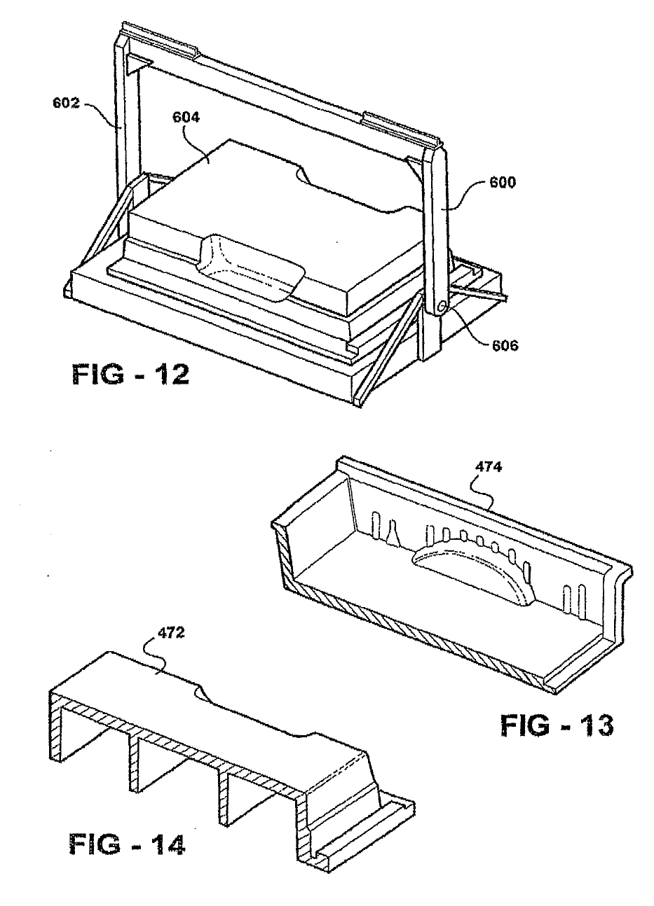

Looking now to FIG. 12, there is shown another embodiment of a trunion 600 used by the present invention for “tipping” the loaded mold(s) in order to empty out the excess plastic particulate after the appropriate time for melting has taken place. A cradle 602 is incorporated into the apparatus and is shown for tipping the mold 604 about a pivot 606, effecting the tip molding method of FIG. 8. FIG. 13 illustrates the preferred embodiment for the lower side of the truck bed mold 474, while FIG. 14 shows the upperside of the truck bed mold 472.

Although the moldable or meltable particulate may be any type of plastic powder, pellets, resin, sheets, blocks, or any other commercially available form of plastic, it may be any suitable polyolefinic chemical composition, so long as it melts at a reasonable temperature. If a metal/metal double skinned material is desired, the core material might be magnesium or aluminum with a different metal for the exterior skins. In the alternative, the core might be metal, with exterior skins of plastic, or the other way around. In the event of the usage of plastic, the plastic may contact the heated mold by any number of methods, including, but not limited to, spraying, either manually, robotically or through spray bars; dumping plastic over the mold and containing the over-dumped amount in a container with the heated mold inside (in the case of a male mold), or it may be dumped or sprayed directly into a female mold. The plastic can be distributed with a shaker arm or may be done manually. Or, the blown in/vacuumed out method as described earlier may be most advantageous in which the plastic may also be blown into a container with the heated male mold inside, or may be blown into the cavity directly, as created by a female mold. In either event, the excess plastic may be vacuumed out of the box or the mold, or the excess may be “tipped” out by rotating the mold to drop the excess plastic from the heated mold.

Yet another embodiment for the process may use a fluidized bed to contact a heated mold with plastic particulate. Although most easily accomplished if the plastic is in the form of powder, the present inventors also envision that the fluidized bed could use pellets after a first layer of powder is melted onto the mold. A fluidized bed configuration may also use the vacuum concept discussed above for introducing the plastic, as well as for flowing and removing the plastic.

Variations on those methods may also be used in the event that a double metal combination is desired, or also in the event that a metal/plastic combination is desired.

Still yet another embodiment for contacting the plastic to the heated mold may include the use of a heated, electrically charged mold coming into contact with an electrically charged plastic which is sprayed toward or onto the surface, and held on the surface of the mold. This electrostatic method may require further layering to achieve a perfectly painted surface once the article is removed from the mold. Since the mold pieces can be “clam-shelled” together after the skin has been formed, this electrostatic method may be able to make very thin skins for the production of thinner, more delicate, articles. For adhesion, the electrostatic method may require the use of an epoxy resin, as is usually used with powder coat paints, known well in the art. However, it is believed that combining the traditional epoxy spraying with heating the electrically charged mold and contacting it with electrically charged plastic particulate is a novel method. Then, when the part is released from the mold, either the heat from the mold will cure the resin paint, or it can be heated even further to impart a beautifully cured painted surface, just like powder coated paint. Or, the plastic particulate could be in the form of a powder that is somewhat electrically charged, and it could be attracted to the heated mold by the electrically charged heated mold. A fine powder would be able to be sprayed on, or used in a fluidized bed, as described above.

A heavier, coarser plastic particulate may be utilized in order to save money on the powder. In this instance, it may be advantageous to incorporate a thin layer of finely ground powder material prior to contacting with the coarser material, in order to encourage a thin, tacky layer of plastic to build up first on the mold, making it easier for the coarse material to heat and “stick” to the mold. True to electrostatic coating, a finer plastic powder which is electrically charged could be attracted to the mold, and then heated while the powder is being held in place by electricity, in order to melt the plastic and form a thin-skinned article. Once the skins have been formed by the electrostatic method, the male and female portions can be “clam-shelled” together and any other inserts and/or reinforcements may be utilized in conjunction with expandable plastic therebetween, similar to the description above.

Now we turn our attention to additional materials, inserts and/or other reinforcements which may be useful in strengthening the plastic forms. Additional materials may render them fire resistant, or as thick or thin as needed. Although this is not an all inclusive list, the following additions are specifically envisioned for various applications: metal screens, grids and meshes, either bare or coated, such as with powder coating, as well as screens, grids and meshes that may be welded or secured with adhesives to prevent lateral shearing motion; thermoelectric devices for heating and/or cooling; slag, lava, and other construction materials to act as heat resistant fillers, fiberglass whether in the form of mesh, woven or non-woven for strength; whisker-filled particulates; conduits or pipelines used for cooling the center of the mold, i.e. pins placed in the mold; electrical wires or conduits placed in the center to house electrical wires; foamed or solid ceramics for adding tensile strength without weight; a pre-formed foam core with a higher melting temperature; metallic structures, such as metal mesh reinforcing cones or other high-rising embeddable structures to add strength; low density stones or other naturally occurring low density materials; wood in any shape to be used for reinforcements or to add strength without adding much weight; metal mounting or securing reinforcements, including metal bars and mounting plates for mounting purposes; whiskers of various glasses such as fiberglass; Kevlar to impart impact and energy dispersion; fire retardant materials; anti-microbial agents to be placed near the surface for alleviating germ transfer; chemical treatments at the surface to reduce chemical interactions with materials being contained within the articles; and any other desirable insert.

Cooling of the heated mold may be accomplished by various means, including, but not limited to utilizing heating/cooling lines within the mold itself; moving the entire plastic/mold assembly into a cooling bath, freezer or refrigerator or some other climate controlled room. Thermoelectric devices may be used in the mold to cool. Once cooled, the plastic article generally pops off the heated mold and does so easily. The cooling configuration could also be in the form of pins that can be inserted within the mold after the heating takes place, and the pins could be refrigerated themselves, or could contain lines that will cool the mold. These pins could be easily removed from the mold so that the next cycle of the mold could be a heated cycle (with heater lines already in the mold—just turned off during the cooling phase).

While many applications have been disclosed, the number of applications is too numerous and staggering to mention. It must be stated that various combinations and permutations of the present invention may be utilized for all the applications mentioned, as well as for ones which were not mentioned. The present invention may be incorporated into the manufacture of so many articles, it would be impossible to list them all here.

### INDUSTRIAL APPLICABILITY

This invention finds utility in the aerospace, aircraft, automotive, housing and marine industries, among others, because it may be used to form environmental and weather resistant encapsulated members that may be used as structural components in the manufacture of vehicles, planes, boats and housing panels.

What is claimed is:

1. An encapsulated member having an outer skin configuration, comprising:
at least one member encapsulated by the outer skin configuration; and
at least a first open encapsulant skin portion and at least a second open encapsulant skin portion, such that said first and second open encapsulant skin portions come together to at least partially collectively form the outer skin configuration.
